(19) United States
(12) Patent Application Publication
(10) Pub. No.: US 2021/0279676 A1
(43) Pub. Date: Sep. 9, 2021

(54) COLD CHAIN IN-TRANSIT EXCHANGE OF PERISHABLE GOODS

(71) Applicant: Carrier Corporation, Plam Beach Gardens, FL (US)

(72) Inventors: Ciara Poolman, Syracuse, NY (US); Robert A. Chopko, Baldwinsville, NY (US); Marc Beasley, Beverly, MA (US)

(21) Appl. No.: 16/317,989

(22) PCT Filed: Jul. 17, 2017
(86) PCT No.: PCT/US2017/042321

§ 371 Date: Jan. 15, 2019

Related U.S. Application Data
(60) Provisional application No. 62/363,599, filed on Jul. 18, 2016.

(51) Int. Cl. G06Q 10/08

(52) U.S. Cl. CPC G06Q 10/0832; G06Q 10/087; G06Q 10/08355

(57) ABSTRACT

A system for facilitating a cold chain in-transit exchange of perishable goods is provided. The system includes a storage device that stores data associated with the perishable goods and a management sub-system that includes a processor and a memory. The management sub-system can be coupled to the storage device. The management sub-system can receive an input comprising the data associated with the perishable goods, perform a quality assessment utilizing the input during a transit period of the perishable goods, and determine whether the cold chain in-transit exchange of the perishable goods should occur based the quality assessment.

### BACKGROUND

The embodiments disclosed herein generally relate to cold chain distribution systems, and more specifically to an apparatus and a method for managing a transport refrigeration unit within a cold chain distribution system.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. For example, transport refrigeration systems are mounted to the truck or to the trailer in operative association with a cargo space defined within the truck or trailer for maintaining a controlled temperature environment within the cargo space, and therefore maintaining a quality of perishable goods.

Currently, when a lower quality good (e.g., mishandling) is received or when the quality of perishable goods degrades (e.g., damaged through improper cooling by the transport refrigeration systems), the perishable goods are either sold as is or scrapped by customer. There is no model for a cold chain in-transit exchange of perishable goods based on market conditions, weather, shelf life, etc.

### SUMMARY

According to an embodiment, a system for facilitating a cold chain in-transit exchange of perishable goods is provided. The system comprises a storage device configured to store data associated with the perishable goods; a management sub-system comprising a processor and a memory, the management sub-system coupled to the storage device, and the management sub-system is configured to: receive an input comprising the data associated with the perishable goods, perform a quality assessment utilizing the input during a transit period of the perishable goods, and determine whether the cold chain in-transit exchange of the perishable goods should occur based the quality assessment.

According to another embodiment or the system embodiment above, the management sub-system can be configured to decrement a grade of the perishable goods in response to determining that the cold chain in-transit exchange of the perishable goods should occur.

According to another embodiment or any of the system embodiments above, the grade of the perishable goods can indicate a present quality of the goods.

According to another embodiment or any of the system embodiments above, the management sub-system can be post the perishable goods for subsequent sale in response to determining that the cold chain in-transit exchange of the perishable goods should occur.

According to another embodiment or any of the system embodiments above, the data can comprise transport parameters associated with the perishable goods.

According to another embodiment or any of the system embodiments above, the data can comprise data comprises historical transport parameters and perishable goods history.

According to another embodiment or any of the system embodiments above, the system can comprise a transport refrigeration unit comprising sensors configured to monitor environmental parameters internal and external to the transport refrigeration unit to the transport parameters.

According to another embodiment or any of the system embodiments above, the perishable goods can comprise one or more of fruits, vegetables, grains, beans, nuts, eggs, dairy, seed, flowers, meat, poultry, fish, ice, blood, and pharmaceuticals.

According to another embodiment or any of the system embodiments above, the transport parameters comprise one or more of a temperature, a pressure, a humidity, a carbon dioxide, an ethylene, an ozone, a light exposure, a location, a speed, an external temperature, and vibrations.

According to another embodiment or any of the system embodiments above, the transit period can comprise a time period encasing a moving of the perishable goods through a cold chain process.

According to another embodiment or any of the system embodiments above, the management sub-system can comprise a diagnostic module configured to perform the quality assessment utilizing the data based on when one or more spoil conditions are present.

According to another embodiment or any of the system embodiments above, the management sub-system can comprise a predictive module configured to perform the quality assessment utilizing the data based on when a future need for the cold chain in-transit exchange is present.

According to another embodiment or any of the system embodiments above, the management sub-system can comprise a remaining life module configured to perform the quality assessment utilizing the data based on when a remaining life of the perishable goods indicates spoiling prior to or soon after delivery to an original destination.

According to an embodiment, a method for facilitating a cold chain in-transit exchange of perishable goods is provided. The method comprises storing, using a storage device, data associated with the perishable goods; receiving, by a management sub-system, an input comprising the data associated with the perishable goods, wherein the management sub-system comprises a processor and a memory and is coupled to the storage device; performing, by a management sub-system, a quality assessment utilizing the input during a transit period of the perishable goods; and determining whether the cold chain in-transit exchange of the perishable goods should occur based the quality assessment.

According to another embodiment or the method embodiment above, the method can comprise decrementing a grade of the perishable goods in response to determining that the cold chain in-transit exchange of the perishable goods should occur; and

According to another embodiment or any of the method embodiments above, the grade of the perishable goods can indicate a present quality of the goods.

According to another embodiment or any of the method embodiments above, the method can comprise posting the perishable goods for subsequent sale in response to determining that the cold chain in-transit exchange of the perishable goods should occur.

According to another embodiment or any of the method embodiments above, the data can comprise transport parameters associated with the perishable goods.

According to another embodiment or any of the method embodiments above, the data can comprise data comprises historical transport parameters and perishable goods history.

According to another embodiment or any of the method embodiments above, the method can comprise monitoring environmental parameters, by sensors of a transport refrigeration unit, internal and external to the transport refrigeration unit to the transport parameters.

According to another embodiment or any of the method embodiments above, the perishable goods can comprise one or more of fruits, vegetables, grains, beans, nuts, eggs, dairy, seed, flowers, meat, poultry, fish, ice, blood, and pharmaceuticals.

According to another embodiment or any of the method embodiments above, the transport parameters comprise one or more of a temperature, a pressure, a humidity, a carbon dioxide, an ethylene, an ozone, a light exposure, and a vibrations.

According to another embodiment or any of the method embodiments above, the transit period can comprise a time period encasing a moving of the perishable goods through a cold chain process.

According to another embodiment or any of the method embodiments above, the method can comprise performing, by a diagnostic module of the management sub-system, the quality assessment utilizing the data based on when one or more spoil conditions are present.

According to another embodiment or any of the system embodiments above, the method can comprise performing, by a predictive module of the management sub-system, the quality assessment utilizing the data based on when a future need for the cold chain in-transit exchange is present.

According to another embodiment or any of the system embodiments above, the method can comprise performing, by a remaining life module of the management sub-system, the quality assessment utilizing the data based on when a remaining life of the perishable goods indicates spoiling prior to or soon after delivery to an original destination.

Other aspects, features, and techniques will become more apparent from the following description taken in conjunction with the drawings.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a cold chain distribution system according to an embodiment of the present disclosure; and

FIG. 2 illustrates a process flow of a marketplace and bidding mechanism according to an embodiment of the present disclosure; and

FIG. 3 illustrates another process flow of a marketplace and bidding mechanism according to an embodiment of the present disclosure.

### DETAILED DESCRIPTION

In general, the disclosure herein relates to a system, method, and/or computer program product (herein collectively referred as the ‘system’) that facilitates a cold chain in-transit exchange of perishable goods. The system includes a marketplace and bidding mechanism, where multiple parties can sell, purchase, and/or reroute perishable goods before they spoil or arrive at (e.g., while in transit to) an original destination. The marketplace and bidding mechanism can utilize weather, hedging based logistics, and road changes to automatically identify the risk of whether a quality of perishable goods is not going to meet requirements upon arrival at the original destination. The marketplace and bidding mechanism can, in turn, suggest whether to reroute shipments of perishable goods to support the selling, purchasing, and/or rerouting of perishable goods. In this way, the system provides a holistic understanding and analysis of perishable goods moving through the cold chain process (e.g., from harvest to consumption).

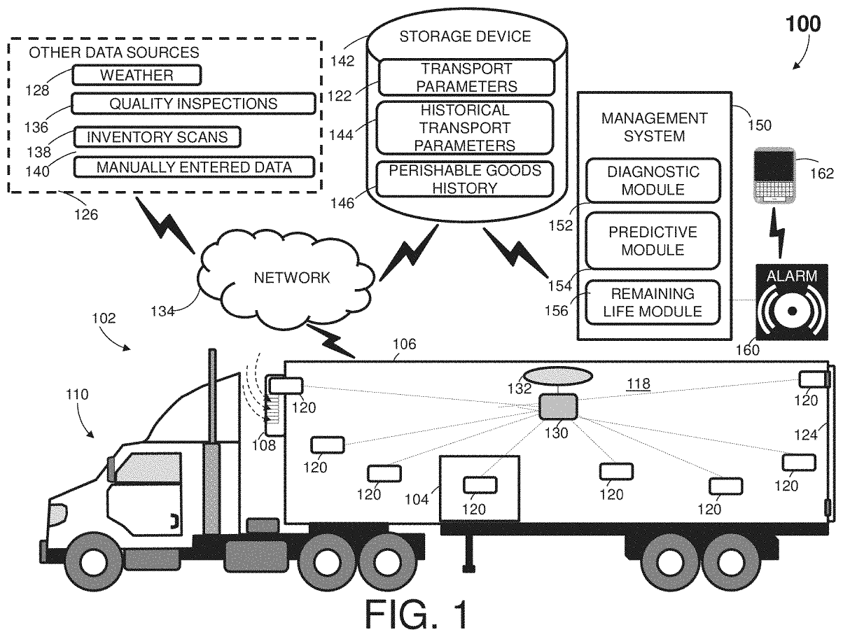

Referring now to the drawings, FIG. 1 illustrates a schematic view of a cold chain distribution system 100 according to an embodiment of the present disclosure. Typically, a transport refrigeration system 102 is used to transport and distribute perishable goods and environmentally sensitive goods (herein referred to as perishable goods 104). In the illustrated embodiment, the transport refrigeration system 102 includes an environmentally controlled container 106, a transport refrigeration unit 108 and perishable goods 104. The container 106 may be pulled by a tractor 110. It is understood that embodiments described herein may be applied to shipping containers that are shipped by rail, sea, or any other suitable container, without use of a tractor 110. The container 106 may define an interior compartment 112.

In the illustrated embodiment, the transport refrigeration unit 108 is associated with a container 106 to provide desired environmental parameters, such as, for example temperature, pressure, humidity, carbon dioxide, ethylene, ozone, light exposure, vibration exposure, and other conditions to the interior compartment 112. In further embodiments, the transport refrigeration unit 108 is a refrigeration system capable of providing a desired temperature and humidity range that reflect normal condition (e.g., non-spoiling conditions) for the perishable goods 104.

The perishable goods 104 may include but are not limited to fruits, vegetables, grains, beans, nuts, eggs, dairy, seed, flowers, meat, poultry, fish, ice, blood, pharmaceuticals, or any other suitable cargo requiring cold chain transport. The perishable goods 104 can be assigned a grade, which indicates a present quality of the goods. The grade can be any scale ranging from spoiled to high quality. The scale can be alpha-numerical (e.g., 0 to 5; A to E; etc.), where each increment indicates the present quality on the scale. For instance, Grade A perishable goods 104 can be of the highest quality fit for human consumption, while Grade C can be a lower quality good fit for human consumption and Grade E can spoiled goods that should be scrapped or is fit for animal feed (each case indicating that the perishable goods 104 are destined for resale at a reduced price). The grade can also be affected according on other data 126 (as described below), such as an appearance or presence of mold, physical damage, color, indication of ripeness, firmness, weight (e.g., water content), flavor, use of certain pesticides.

In the illustrated embodiment, the transport refrigeration system 102 includes sensors 120. The sensors 120 may be utilized to monitor transport parameters 122 internal and external to the container 106 and/or the transport refrigeration unit 102. The transport parameters 122 monitored by the sensors 120 may include but are not limited to temperature, pressure, humidity, carbon dioxide, ethylene, ozone, light exposure, vibrations, and other conditions of the perishable goods 104. The transport parameters 122 monitored by the sensors 120 can also include speed, location, external temperature, and other conditions of the transport refrigeration system 102. Accordingly, suitable sensors 120 are utilized to monitor the desired parameters. Advantageously, sensors 120 may be selected for certain applications depending on the perishable cargo to be monitored and the corresponding environmental sensitivities. In an embodiment, temperatures are monitored. In certain embodiments, a user desires to maintain and monitor temperatures or other parameters within an acceptable range. As seen in FIG. 1, the sensors 120 may be placed directly on the perishable goods 104.

Further, as in the illustrated embodiment, sensors 120 may be used to monitor various transport parameters 122 of the transport refrigeration system 102. These sensors 120 may be placed in a variety of locations including but not limited to on the transport refrigeration unit 108, on a door 124 of the container 106 and throughout the interior compartment 112. The sensors 120 may be placed directly within the transport refrigeration unit 108 to monitor the performance of the transport refrigeration unit 108. Individual components internal to the transport refrigeration unit 108 may also be monitored by sensors 120 to detect performance aspects, such as, for example usage cycles, duration, temperatures and pressure of individual components. As seen, the sensors 120 may also be placed on the door 124 of the container 106 to monitor the position of the door 124. Whether the door 124 is open or closed affects both the temperature of the container 106 and the performance of the transport refrigeration unit 108. For instance, in hot weather, an open door 124 will allow cooled air to escape from the container 106, causing the temperature of the interior compartment 112 to rise, which creates additional stress on the transport refrigeration unit 108 by forcing the transport refrigeration unit 108 to work harder to cool the interior compartment 112. Additionally, the global positioning system (GPS) location may also be detected by the sensors 120. The GPS location may help in providing information from other data sources 126 regarding local weather 128 (including solar gain) experienced by the container 106 along the travel route. The local weather 128 affects the temperature of the container 106 and thus affects the operation on the transport refrigeration unit 108. For instance, the transport refrigeration unit 108 may have to work harder on a container 106 travelling through a desert that is exposed to long period of heat and solar gain.

As illustrated in FIG. 1, the transport refrigeration system 102 may further include, a controller 130 configured to log a plurality of readings from the sensors 120, known as transport parameters 122, at a selected sampling rate. The controller 130 may be enclosed within the transport refrigeration unit 108 or separate from the transport refrigeration unit 108 as illustrated. The transport parameters 122 may further be augmented with time, position stamps, or other relevant information. The controller 130 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 102 may include a communication module 132 in operative communication with the controller 130 and in wireless operative communication with a network 134. The communication module 132 is configured to transmit the transport parameters 122 to the network 134 via wireless communication. The wireless communication may be, but is not limited to, radio, microwave, cellular, satellite, or another wireless communication method. The network 134 may be but is not limited to satellite networks, cellular networks, cloud computing network, wide area network, or another type of wireless network. The communication module 132 may include a short range interface, wherein the short range interface includes at least one of: a wired interface, an optical interface, and a short range wireless interface.

Transport parameters 122 may also be provided by other data sources 126, as illustrated in FIG. 1. These other data sources 126 may be collected at any point throughout the cold chain distribution system 100, which may include harvest, packing, storage prior to transport, transport to distribution center, distribution center, transport to display, storage prior to display, display, and consumer. These stages are provided for illustrative purposes and a distribution chain may include fewer stages or additional stages, such as, for example a cleaning stage, a processing stage, and additional transportation stages. The other data sources 126 may include, but are not limited to, weather 128, quality inspections 136, inventory scans 138, and manually entered data 140. The other data sources 126 may also include supply chain that can delay or put cargo at risk, such as road conditions, sea port delays due to strikes or accidents, problems at critical junctures like the Suez or Panama Canals, air travel stopped or rerouted due to volcanic activity, border crossings delays, etc.

The weather 128, as discussed above, has an effect on the operation of the transport refrigeration unit 108 by influencing the temperature of the container 106 during transport. The weather 128 also has other influences on the transport refrigeration unit 108. For instance, the weather 128 prior to and at harvest may have an impact on the quality of the perishable goods 104, which in turn would affect how hard the transport refrigeration unit 108 must work to preserve the perishable goods 104. Moreover, quality inspections 136, similar to the weather 128, may reveal data of the perishable goods 104 that may affect how hard the transport refrigeration unit 108 must work to preserve the perishable goods 104. Quality inspections 136 may be done by a machine or a human being. Quality inspections 136 performed by a machine may be accomplished using a variety of techniques including but not limited to optical, odor, soundwave, infrared, or physical probe.

Further inventory scans 138, may also reveal information about the perishable goods 104 that may affect how hard the transport refrigeration unit 108 must work to preserve the perishable goods 104. For instance, the inventory scan 138 may reveal a temperature of the distribution center where the perishable goods 104 were kept and thus the transport refrigeration unit 108 must either increase or decrease its output to bring the perishable goods 104 to the correct temperature. While the system 100 includes sensors 120 to aid in automation, often times the need for manual data entry is unavoidable. The manually entered data 140 may be input via a variety of devices including but not limited to a cellular phone, tablet, laptop, smartwatch, a desktop computer or any other similar data input device.

In the illustrated embodiment, the cold chain distribution system 100 further includes a storage device 142 to store data associated with the transport refrigeration unit 108 and/or the perishable goods 104, such as the transport parameters 122. The data of the storage device 142 may also store historical transport parameters 144 and perishable goods history 146 of the transport refrigeration unit 108 and/or the perishable goods 104. The storage device 142 may be but is not limited to a random access memory (RAM), read only memory (ROM), or other electronic, optical, magnetic or any other computer readable medium.

In the illustrated embodiment, the system 100 further includes a management system 150 (e.g., a marketplace and bidding mechanism). As shown, the management system 150 may include a diagnostic module 152, a predictive module 154, and a remaining life module 156. The management system 150 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The diagnostic module 152 determines a condition of the transport refrigeration unit 108 and/or the perishable goods 104 based on the data of the storage device 142, such as the transport parameters 122, historical transport parameters 144, and/or perishable goods history 146. The diagnostic module 152 may detect spoil conditions in the transport refrigeration unit 108 and provide an indication of the potential sources for the spoil conditions. Spoil conditions are environmental parameters that will cause the perishable goods 104 to be downgraded or spoil (be unacceptable for consumption) prior to or soon after delivery, thereby decreasing and/or removing the market value of the perishable goods 104. The diagnostic module 152 may compare the transport parameters 122 to thresholds, limits, ranges, etc. to detect the spoil conditions and then access historical transport parameters 144 and/or the perishable goods history 146 to derive one or more potential sources for the spoil conditions. The diagnostic module 152 activates an alarm 160 when a condition is, for example, outside of a selected range of conditions (e.g., when a spoil condition is present). The diagnostic module 152 can alter a grade of the perishable goods 104 when one or more spoil conditions are present and/or cause the management system 150 to suggest a cold chain in-transit exchange of perishable goods 104 when one or more spoil conditions are present.

The predictive module 154 determines a future need for cold chain in-transit exchange of perishable goods 104 based on the data of the storage device 142, such as the transport parameters 122. For example, the predictive module 154 determines environmental parameters that will eventually cause the perishable goods 104 to be downgraded or spoil prior to or soon after delivery. The predictive module 154 activates an alarm 160 when the future need for the cold chain in-transit exchange of perishable goods 104 is determined. The predictive module 154 may detect patterns in the transport parameters (e.g., patterns of high/low compressor outlet pressure) to predict spoiling. The predictive module 154 may also detect trends in the transport parameters 122, compare the transport parameters 122 to thresholds and/or determine rates of change in transport parameters 122 to determine the future need for the cold chain in-transit exchange of perishable goods 104. The existence of a series of alarm occurrences (e.g., over-pressure) may indicate the future need for the cold chain in-transit exchange of perishable goods 104. The predictive module 154 can alter a grade of the perishable goods 104 when the future need is present for the cold chain in-transit exchange of perishable goods 104 is determined and/or cause the management system 150 to suggest a cold chain in-transit exchange of perishable goods 104 when the future need is present.

The remaining life module 156 determines a remaining life of the perishable goods 104 based on the data of the storage device 142, such as the transport parameters 122. The remaining life module 156 activates an alarm 160 when the remaining life of the perishable goods 104 equals a selected grade. The remaining life module 156 may use a baseline life curve which provides remaining life as a function of time. The baseline life curve may be generated based on the historical transport parameters 144 and/or the perishable goods history 146. The baseline life curve may be adjusted or shifted in response to events or transport parameters 122 and/or the perishable goods history 146. For example, detection of operation under harsh high ambient conditions may reduce the remaining life. The remaining life module 156 can alter a grade of the perishable goods 104 when a remaining life of the perishable goods 104 indicates spoiling prior to or soon after delivery to an original destination and/or cause the management system 150 to suggest a cold chain in-transit exchange of perishable goods 104 when the remaining life of the perishable goods 104 indicates spoiling prior to or soon after delivery to the original destination.

The diagnostic module 152, predictive module 154, and remaining life module 156 can utilize historical transport parameters 144 from other transport refrigeration units and the perishable goods history 146 of the current transport refrigeration unit 108 in their determinations. The historical transport parameters 144 may provide information such as, for example, life curves, failure rates, and a selected range of conditions for each component of the transport refrigeration unit 108. The selected range of conditions may define the normal operating conditions of component of the transport refrigeration unit 108 (e.g., which relate to non-spoiling conditions for the perishable goods 104). Operation outside of the selected range of conditions may indicate an issue with a component of the transport refrigeration unit 108, therefore possible spoiling conditions. The perishable goods history 146 may help indicate persistent issues with the perishable goods 104. The perishable goods history 146 may also help the predictive module 154 cause the management system 150 to suggest the cold chain in-transit exchange of perishable goods 104.

The alarm 160 can be an alert sent to a user device 162 such as, for example, a cellular phone, tablet, laptop, smartwatch, desktop computer or any similar device. The alarm 160 may be an instantaneous alarm or a scheduled alarm for a later time. For instance, the predictive module 154 may predict that the perishable goods 104 should be scheduled for early delivery, so the predictive module 154 may schedule the alarm 160 to go off a little in advance of the early delivery. Whereas, if the diagnostic module 152 determines that the perishable goods 104 are currently outside a selected range of conditions, the diagnostic module 152 may activate the alarm 160 immediately to avoid spoiling. Therefore, the alarm 160 can cause the cold chain in-transit exchange of perishable goods 104.

Advantageously, as provided herein, the management system 150 may help to better predict delivery schedules and reduce spoiling of the perishable goods 104. In some embodiments, advantageously, the management system 150 may suggest re-routing transport refrigeration systems 102 so they do not embark on a journey that the transport refrigeration unit 108 cannot complete.

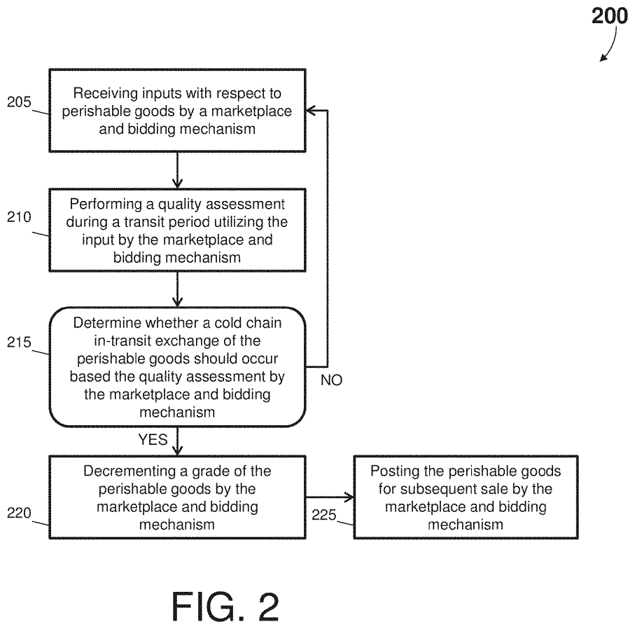

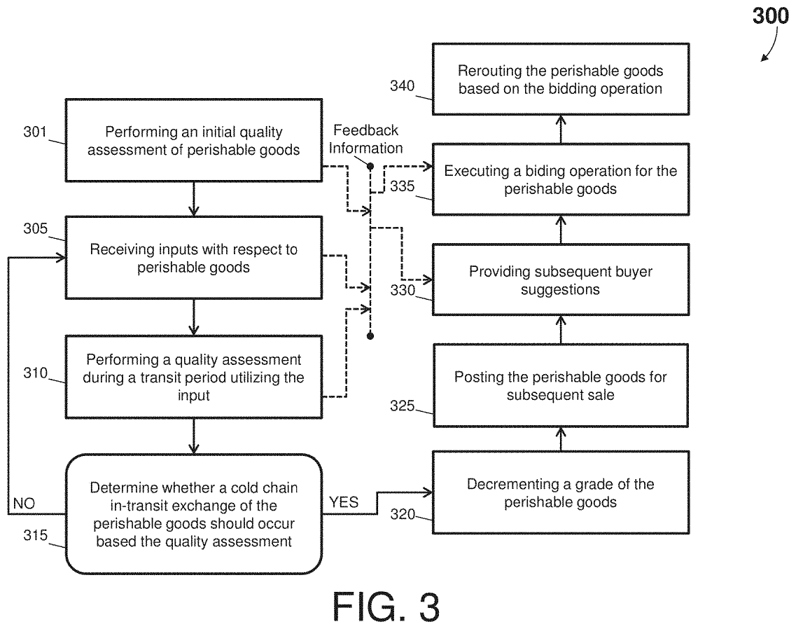

Operations of the management system 150 will now be described with respect to FIGS. 2 and 3. FIG. 2 illustrates a process flow 200 of the management system 150, operating as a marketplace and bidding mechanism, according to an embodiment. The process flow 200 begins at block 205, where inputs with respect to perishable goods are received by the marketplace and bidding mechanism. In an embodiment, the management system 150 receives one or more inputs. The one or more inputs can comprise the data of the storage device 142, such as the above transport parameters 122, historical transport parameters 144, and/or perishable goods history 146. The receiving of the one or more inputs by the management system 150 can include active pushing or pulling operations/communications by the management system 150 to and from the sensors 120, the controller 130, the communication module 132, the storage device 142, and/or the other data sources 126.

At block 210, a quality assessment during a transit period utilizing the input of block 205 is performed by the marketplace and bidding mechanism. In an embodiment, the management system 150 performs during the transit period the quality assessment. The transit period comprises a time period encasing the moving of the perishable goods 104 through the cold chain process (e.g., from harvest to consumption). The quality assessment is a monitoring by the diagnostic module 152, the predictive module 154, and the remaining life module 156 of the management system 150 of the perishable goods 104 as described above. The monitoring can be a continuous or on-going, occur on scheduled instances, occur on random instances, and/or be user driven

At block 215, the marketplace and bidding mechanism determines whether a cold chain in-transit exchange of the perishable goods should occur based the quality assessment. In an embodiment, the management system 150 utilizes the diagnostic module 152, the predictive module 154, and the remaining life module 156 to make the cold chain in-transit exchange determination in real-time (e.g., utilizes weather, hedging based logistics, and road changes to automatically identify if a quality of perishable goods 104 is not going to meet requirements upon arrival at an original destination). For instance, the management system 150 utilizes the diagnostic module 152 to suggest a cold chain in-transit exchange of perishable goods 104 when one or more spoil conditions are present. Further, the management system 150 utilizes the predictive module 154 to suggest a cold chain in-transit exchange of perishable goods 104 when the future need is present. Furthermore, the management system 150 utilizes the remaining life module 156 to suggest a cold chain in-transit exchange of perishable goods 104 when a remaining life of the perishable goods 104 indicates spoiling prior to or soon after delivery to the original destination.

As shown in FIG. 2, if the cold chain in-transit exchange of the perishable goods is not required according to the determination of block 215, the process flow 200 loops back to block 205 (as indicated by the ‘NO’ arrow). However, if the cold chain in-transit exchange of the perishable goods is required, the process flow 200 proceeds to block 220 (as indicated by the ‘YES’ arrow).

At block 220, the marketplace and bidding mechanism decrements a grade of the perishable goods. In an embodiment, the management system 150 utilizes the diagnostic module 152, the predictive module 154, and the remaining life module 156 to make the grade determination. For instance, the management system 150 utilizes the diagnostic module 152 to alter a grade of the perishable goods 104 when one or more spoil conditions are present. Further, the management system 150 utilizes the predictive module 154 to alter a grade of the perishable goods 104 when the future need is present. Furthermore, the management system 150 utilizes the remaining life module 156 to alter a grade of the perishable goods 104 when a remaining life of the perishable goods 104 indicates spoiling prior to or soon after delivery to an original destination.

At block 225, the marketplace and bidding mechanism posts the perishable goods 104 for subsequent sale by the marketplace and bidding mechanism. In an embodiment, the management system 150 can manage an interface that buyers can access so as to bid on the downgraded the perishable goods 104. The interface can be any user interface, software portal, or computer tool that enables bidding, sale, resale, negations, and/or communications with respect to the perishable goods 104 (e.g., multiple buyers can sell, purchase, and/or reroute the perishable goods 104 in real-time before they spoil or arrive at an original destination). For example, the user interface can be website or a collection of related web pages, including multimedia content, published on at least computer server connected to the network 134. The website via the computer server may be accessible via a public Internet Protocol (IP) network, such as the Internet, or a private local area network (LAN), such as an intranet, by referencing a uniform resource locator (URL) that identifies the site.

Within the context of the interface, the management system 150 can offer the perishable goods 104, which were downgraded in block 220, for subsequent sale to another buyer at a reduced or fractional price. Within the context of the interface, buyers can actively browse and purchase the perishable goods 104 that were downgraded in block 220 at a reduced or fractional price. The reduced or fractional price can be proportional to the grade given in block 220 and/or altered based on bidding and/or negotiations within the interface.

Once a purchase is complete, the management system 150 can automatically reroute shipments of perishable goods 104. The management system 150 can support the selling, purchasing, and/or rerouting of the perishable goods 104 by suggesting buyers who may have a need for the management system 150 (e.g., animal farmer local to where the perishable goods 104 were downgraded).

In view of the above, an example operation of the process flow 200 will now be described. The management system 150 identifies that a cargo of perishable goods 104 have been purchased from a grower by a first buyer. Further, the management system 150 identifies that the cargo is going from the grower to a location (e.g., original destination) determined by the first buyer. The management system 150 then pulls in real-time the transport parameters 122 (e.g., one or more inputs) from the sensors 120 through the communications module 132, while the cargo is being moved by the transport refrigeration system 102. The management system 150 performs on-going quality assessments of the transport parameters 122 (and in turn the cargo) to provides a holistic understanding and analysis of the perishable goods 104 moving through from the grower harvest to the original destination (e.g., the cold chain process). If at any point during the cold chain process the management system 150 determines that a quality of the cargo has dropped, the management system 150 decrement a grade of the perishable goods 104. This decrease in grade will allow the first buyer 1 to trade that shipment with a second buyer 2 within the interface, where the second buyer can see the grade. Upon completion of the online trade, the management system 150 sends updated navigation data to an operator of the transport refrigeration system 102 to re-route the cargo to a second destination.

Turning now to FIG. 3, a process flow 300 of the management system 150, operating as a marketplace and bidding mechanism, is illustrated according to an embodiment. The process flow 300 begins at block 301, where the management system 150 performs an initial quality assessment of perishable goods 104. The initial quality assessment can be utilized as a baseline for providing feedback information during subsequent operations of the management system 150.

At block 305, inputs with respect to perishable goods 104 are received by the management system 150. At block 310, a quality assessment during a transit period utilizing the input of block 205 is performed by the management system 150. At block 315, the management system 150 determines whether a cold chain in-transit exchange of the perishable goods should occur based the quality assessment.

As shown in FIG. 3, if the cold chain in-transit exchange of the perishable goods is not required according to the determination of block 315, the process flow 300 loops back to block 305 (as indicated by the ‘NO’ arrow). However, if the cold chain in-transit exchange of the perishable goods is required, the process flow 300 proceeds to block 320 (as indicated by the ‘YES’ arrow). At block 320, the management system 150 decrements a grade of the perishable goods. At block 325, the management system 150 posts the perishable goods 104 for subsequent sale.

At block 330, the management system 150 provides subsequent buyer suggestions. The management system 150 can provide the subsequent buyer suggestions based on feedback information. The feedback information can comprise the initial quality assessment of block 301, the inputs of block 305 (e.g., real time transport parameters 122), and the on-going quality assessments of block 310. The feedback information can also comprise weather, hedging based logistics, and road changes so that the management system 150 can automatically identify if a quality of perishable goods 104 is not going to meet requirements upon arrival at the original destination. The subsequent buyer suggestions can, in turn, be buyers that are located closer to an originating location of the cargo than the original destination. The subsequent buyer suggestions can be provided to a grower or original seller of the perishable goods 104. These subsequent buyers themselves can also be notified. In turn, the grower or original seller and subsequent buyers can all be party to a biding operation for the cargo.

At block 335, the management system 150 executes the biding operation for the perishable goods 104. Subsequent buyers can actively browse, purchase, bid and/or negotiate within the interface for rights to the perishable goods 104. The interface can start the bidding at a reduced or fractional price that is proportional to the grade given in block 320. The price can be altered based on the feedback information.

At block 340, the management system 150 reroutes the perishable goods 104 based on the biding operation. Once a purchase is complete, the management system 150 can automatically reroute shipments of perishable goods 104.

The technical effects and benefits of the marketplace and bidding mechanism includes enabling multiple parties can sell, purchase, and/or reroute perishable goods before they spoil or arrive at (e.g., while in transit to) an original destination. The technical effects and benefits of the marketplace and bidding mechanism also include enabling the use of weather, hedging based logistics, and road changes to automatically identify if a quality of perishable goods is not going to meet requirements upon arrival at the original destination. The technical effects and benefits of the marketplace and bidding mechanism also include enabling the use of suggestions as to whether to reroute shipments of perishable goods to support the selling, purchasing, and/or rerouting of perishable goods. The marketplace and bidding mechanism is necessarily routed in a computing system to provide holistic understanding and analysis of perishable goods moving through the cold chain process so as to solve perishable goods being wasting and completely losing their market value.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A system for facilitating a cold chain in-transit exchange of perishable goods, the system comprising:
a storage device configured to store data associated with the perishable goods;
a management sub-system comprising a processor and a memory, the management sub-system coupled to the storage device, and the management sub-system is configured to:
receive an input comprising the data associated with the perishable goods,
perform a quality assessment utilizing the input during a transit period of the perishable goods,
determine whether the cold chain in-transit exchange of the perishable goods should occur based the quality assessment, and
post the perishable goods for subsequent sale in response to determining that the cold chain in-transit exchange of the perishable goods should occur.

2. The system of claim 1, wherein the management sub-system is configured to decrement a grade of the perishable goods in response to determining that the cold chain in-transit exchange of the perishable goods should occur.

3. The system of claim 2, wherein the grade of the perishable goods indicates a present quality of the goods.

4. (canceled)

5. The system of claim 1, wherein the data comprises transport parameters associated with the perishable goods.

6. The system of claim 1, wherein the data comprises historical transport parameters and perishable goods history.

7. The system of claim 1, the system comprising:
a transport refrigeration unit comprising sensors configured to monitor environmental parameters internal and external to the transport refrigeration unit to the transport parameters.

8. The system of claim 1, wherein the perishable goods comprise one or more of fruits, vegetables, grains, beans, nuts, eggs, dairy, seed, flowers, meat, poultry, fish, ice, blood, and pharmaceuticals.

9. The system of claim 1, wherein the transport parameters comprise one or more of a temperature, a pressure, a humidity, a carbon dioxide, an ethylene, an ozone, a light exposure, a location, a speed, an external temperature, and vibrations.

10. The system of claim 1, wherein the transit period comprises a time period encasing a moving of the perishable goods through a cold chain process.

11. The system of claim 1, wherein the management sub-system comprises a diagnostic module configured to perform the quality assessment utilizing the data based on when one or more spoil conditions are present.

12. The system of claim 1, wherein the management sub-system comprises a predictive module configured to perform the quality assessment utilizing the data based on when a future need for the cold chain in-transit exchange is present.

13. The system of claim 1, wherein the management sub-system comprises a remaining life module configured to perform the quality assessment utilizing the data based on when a remaining life of the perishable goods indicates spoiling prior to or soon after delivery to an original destination.

14. A method for facilitating a cold chain in-transit exchange of perishable goods, the method comprising:
storing, using a storage device, data associated with the perishable goods;
receiving, by a management sub-system, an input comprising the data associated with the perishable goods, wherein the management sub-system comprises a processor and a memory and is coupled to the storage device;
performing, by a management sub-system, a quality assessment utilizing the input during a transit period of the perishable goods; and
determining whether the cold chain in-transit exchange of the perishable goods should occur based the quality assessment, and
posting the perishable goods for subsequent sale in response to determining that the cold chain in-transit exchange of the perishable goods should occur.

15. The method of claim 14, the method comprising:
decrementing a grade of the perishable goods in response to determining that the cold chain in-transit exchange of the perishable goods should occur.

16. The method of claim 15, wherein the grade of the perishable goods indicates a present quality of the goods.

17. The method of claim 14, wherein the data comprises transport parameters associated with the perishable goods.

18. The method of claim 14, wherein the data comprises historical transport parameters and perishable goods history.

19. The method of claim 14, the method comprising:
monitoring, by a transport refrigeration unit comprising sensors, environmental parameters internal and external to the transport refrigeration unit to the transport parameters.

20. The method of claim 14, wherein the perishable goods comprise one or more of fruits, vegetables, grains, beans, nuts, eggs, dairy, seed, flowers, meat, poultry, fish, ice, blood, and pharmaceuticals.

21. The method of claim 14, wherein the transport parameters comprise one or more of a temperature, a pressure, a humidity, a carbon dioxide, an ethylene, an ozone, a light exposure, a location, a speed, an external temperature, and vibrations.
